(19) United States
(12) Patent Application Publication
(10) Pub. No.: US 2017/0200569 A1
(43) Pub. Date: Jul. 13, 2017

(54) METHOD FOR PRODUCING SOLID ELECTROLYTIC CAPACITOR ELEMENT

(71) Applicant: SHOWA DENKO K.K., Tokyo (JP)

(72) Inventors: Kazumi NAITO, Tokyo (JP); Shoji YABE, Tokyo (JP)

(73) Assignee: SHOWA DENKO K.K., Tokyo (JP)

(21) Appl. No.: 15/326,124

(22) PCT Filed: Mar. 30, 2015
(86) PCT No.: PCT/JP2015/059942

§ 371 Date: Jan. 13, 2017

(30) Foreign Application Priority Data
Jul. 16, 2014 (JP) 2014-145717

(51) Int. Cl. H01G 11/86

(52) U.S. Cl. CPC H01G 11/86

(57) ABSTRACT

A method for producing a solid electrolytic capacitor element, which includes, in the following order, a sintering step of sintering a valve-acting metal to form an anode body, a chemical conversion step to form a dielectric layer on the surface layer of the anode body, a step of forming a semiconductor layer comprising a conductive polymer by immersing the anode body in a solution of monomers of a conductive polymer to thereby polymerize the monomers, and a step of forming a conductor layer on the anode body. The method is characterized in conducting the step of forming a semiconductor layer under the condition where photopolymerization of the monomers of the conductive polymer is not caused.

### TECHNICAL FIELD

The present invention relates to a method for producing a solid electrolytic capacitor element. Specifically, the present invention provides a highly-productive method for producing a solid electrolytic capacitor element, while suppressing the production of defective products such as unsealed products.

### BACKGROUND ART

Patent Document 1 discloses a photopolymerization apparatus and a photopolymerization method that are capable of suitably forming a reaction product comprising an electroconductive polymer.

Patent Document 2 discloses a method for synthesizing benzo[c]thiophene by irradiating a gas phase, a liquid phase or a solid phase comprising a 1,3-dihydrobenzo[c]thiophene compound.

Patent Document 3 discloses a moldable or film-forming composition capable of producing a conductive composite material, in which material, monomers are polymerized by light irradiation and only the irradiated region is turned into being conductive to thereby be homogeneously mixed with a general-purpose polymer.

As described above, it is known that monomers of general conductive polymers can be polymerized by light.

### PRIOR ART

### Patent Documents

Patent Document 1: JP 2006-290912 A

Patent Document 2: JP H05-255486 A

Patent Document 3: JP H07-188399 A

### DISCLOSURE OF INVENTION

### Problem to be Solved by Invention

A solid electrolytic capacitor element can be produced by a method comprising, in the following order, a sintering step of sintering a valve-acting metal to form an anode body, a chemical conversion step to form a dielectric layer on the surface layer of the anode body, a step of forming a semiconductor layer by immersing the anode body in a solution of monomers of a conductive polymer to thereby polymerize the monomers, and a step of forming a conductor layer on the anode body.

When a semiconductor layer is formed by a conventional method, darkened portions or floating substances are generated in the solution of monomers of a conductive polymer used for forming a semiconductor layer after the formation of the semiconductor layer in some cases. The darkened portions and floating substances attach to the semiconductor layer and may generate defective products such as unsealed products.

Therefore, an objective of the present invention is to solve the above-described problem and to provide a highly-productive method for producing a solid electrolytic capacitor element while suppressing the production of defective products such as unsealed products.

### Means to Solve Problems

The present inventors inferred from the teachings of Patent Documents 1 to 3 that inappropriate photopolymerization of the monomers of the conductive polymer in the monomer solution causes the darkening and floating substances. They considered that prevention of the photopolymerization to prevent the generation of the darkening and the floating substances is an essential task to reduce the defective products such as unsealed products. As a result, they have accomplished the following invention. That is, the present invention relates to the following items [1] to [6].

[1] A method for producing a solid electrolytic capacitor element, which comprises, in the following order, a sintering step of sintering a valve-acting metal to form an anode body, a chemical conversion step to form a dielectric layer on the surface layer of the anode body, a step of forming a semiconductor layer comprising a conductive polymer by immersing the anode body in a solution of monomers of a conductive polymer to thereby polymerize the monomers, and a step of forming a conductor layer on the anode body; and which is characterized in conducting the step of forming a semiconductor layer under the condition where photopolymerization of the monomers of the conductive polymer is not caused.
[2] The method for producing a solid electrolytic capacitor element as described in [1] above, wherein the condition where photopolymerization of the monomers of the conductive polymer is not caused is a condition that a cumulative light amount for radiation of the light having a wavelength of 150 to 450 nm in the step of forming a semiconductor layer is set to 10 mJ/cm² or less.
[3] The method for producing a solid electrolytic capacitor element as described in [1] or [2] above, wherein the conductive polymer is at least one member selected from polyethylenedioxythiophene, polypyrrole, and derivatives thereof.
[4] The method for producing a solid electrolytic capacitor element as described in [1] above, wherein the condition where photopolymerization of the monomers of the conductive polymer is not caused is a light-shielding condition.
[5] The method for producing a solid electrolytic capacitor element as described in any one of [1] to [4] above, wherein the valve-acting metal is at least one member selected from tantalum, niobium, tungsten and aluminum.
[6] The method for producing a solid electrolytic capacitor element as described in [5] above, wherein the valve-acting metal is tantalum and/or tungsten.

### Effects of Invention

The present invention can prevent inappropriate photopolymerization of the monomers of the conductive polymer in the step of forming a semiconductor layer. As a result, defective products such as unsealed products in the produced solid electrolytic capacitor elements are decreased and the productivity is improved.

### BRIEF DESCRIPTION OF DRAWINGS

FIG. 1 is a stereomicroscope photo (20-fold magnification) for showing the surface of the anode body after the step of forming a semiconductor layer in Example 2.

FIG. 2 is a stereomicroscope photo (20-fold magnification) for showing the surface of the anode body after the step of forming a semiconductor layer in Comparative Example 2.

### MODE FOR CARRYING OUT INVENTION

The method for producing a solid electrolytic capacitor element of the present invention is a method for producing a solid electrolytic capacitor element, which comprises, in the following order, a sintering step of sintering a valve-acting metal to form an anode body, a chemical conversion step to form a dielectric layer on the surface layer of the anode body, a step of forming a semiconductor layer by immersing the anode body in a solution of monomers of a conductive polymer to thereby polymerize the monomers, and a step of forming a conductor layer on the anode body; and which is characterized in conducting the step of forming a semiconductor layer under the condition where photopolymerization of the monomers of the conductive polymer is not caused.

In a conventional method, a semiconductor layer is formed in a state where the anode body and the monomer solution are irradiated by the light such as fluorescent lights in order to confirm the progress of the formation of the semiconductor layer or for need of various operation. The present inventors assumed that this causes inappropriate photopolymerization of the monomers of the conductive polymer and generates the darkening and floating substances in the monomer solution, leading cause of defective sealing.

Accordingly, in the production method of the present invention, the step of forming a semiconductor layer is conducted under the condition where photopolymerization of the monomers of the conductive polymer is not caused to prevent the darkening and floating substances in the monomer solution. The condition where photopolymerization of the monomers of the conductive polymer is not caused is preferably a condition that a cumulative light amount for radiation of the light having a wavelength of 150 to 450 nm in the step of forming a semiconductor layer is set to 10 mJ/cm² or less, and more preferably, a light-shielding condition.

Some of the insulating metal oxides constituting the dielectric layer of the solid electrolytic capacitor element are photoactive. Therefore, if a semiconductor layer is formed in a state where the anode body and the monomer solution are illuminated, the insulating metal oxide is photoactivated and may promote the above-mentioned inappropriate photopolymerization of the monomers of the conductive polymer or cut the conductive polymer formed as a semiconductor layer. The production method of the present invention can prevent the foregoing and can form a semiconductor layer more suitably by forming a semiconductor layer under the condition where photopolymerization of the monomers of the conductive polymer is not caused.

For example, when tungsten is used as a valve-acting metal, the main component of the dielectric layer becomes tungsten trioxide. Since tungsten trioxide is highly photoactive, it is desirable to employ the production method of the present invention.

The present invention is described below in details.

As a valve-acting metal, preferred is a valve-acting metal such as tantalum, niobium, tungsten and aluminum, and an alloy and a composition mainly comprising these metals, and a conductive oxide of these metals. Two or more kinds of these powders may be mixed to be used. Here, the alloy includes the one in which part of the metal is alloyed.

The anode body may contain a metal other than the main components within a scope which does not affect the capacitor properties. Metals other than the main component include a valve-acting metal such as tantalum, niobium, aluminum, titanium, vanadium, zinc, molybdenum, hafnium and zirconium.

In the case of using tungsten as a valve-acting metal, a commercially-available tungsten powder can be used as a raw material tungsten powder. A tungsten powder having a smaller particle diameter than a commercially-available tungsten powder by a method such as reducing the tungsten trioxide powder under hydrogen gas atmosphere can also be used suitably.

As a tungsten powder, a granulated tungsten powder (hereinafter, may be referred to as the “granulated powder”) facilitates formation of fine pores in an anode body and is preferable. As a granulated tungsten powder, at least one member of a silicified tungsten powder, a carbonated tungsten powder, a boronized tungsten powder and a tungsten powder containing a nitrogen solid solution can be suitably used. The above-described granulated tungsten powder includes the one in which part of the tungsten powder is silicified, carbonated, boronized, and the one that partially contains a nitrogen solid solution.

A silicified tungsten powder can be obtained by, for example, mixing the silicon powder well into the tungsten powder and heating the mixture under reduced pressure. In the case of using this method, tungsten silicide such as W₅Si₃ is formed and localized generally in a region within 50 nm from the surface layer of the tungsten particles. Hence, the core of the primary particles remains as a highly-conducting metal, which suppresses the equal serial resistance of the anode body produced using the tungsten powder, which is preferable.

The pressure at the time of silicifying tungsten is set to 10⁻¹ Pa or lower, preferably 10⁻³ Pa or lower. The reaction temperature is preferably 1,100° C. or higher and 2,600° C. or lower. When the reaction temperature is set within the range, the silicification does not take too long a time. At the same time, it makes it less likely that the silicon evaporates and is alloyed with the electrode metal (such as molybdenum) and thereby causes a problem such that the electrode becomes fragile.

The tungsten powder may further contain oxygen and phosphorus.

To attain better LC characteristics in the tungsten powder, it is preferable to keep the total content of impurity elements other than each element of silicon, carbon, boron, nitrogen, oxygen and phosphorus in the powder to 0.1 mass % or less.

Forming treatment may be conducted before sintering the above-mentioned valve-acting metal. The valve-acting metal to be formed may be either of a granulated powder, an ungranulated powder, or a mixture of a granulated powder and an ungranulated powder. A binder may be mixed with the powder to facilitate the pressure forming. By controlling the formation pressure, the fine pore rate of the anode body and the density of the formed product can be adjusted.

In the formation of the valve-acting metal powder, an anode lead wire serving as a terminal of the anode body may be embedded and implanted in the formed body. As an anode lead wire, a valve-acting metal wire can be used, and also a metal plate or a metal foil may be implanted in or connected to the anode body.

<Sintering Step>

In the sintering step, a valve-acting metal is sintered to form an anode body. The valve-acting metal may be an ungranulated powder, or may be granulated or formed as described above.

The anode body may be formed in a shape such as a foil, a plate and a wire. If a porous body having fine pores or voids between the internal particles is formed, it is preferable because it increases the capacitance of the capacitor element produced thereof. Such an anode body can be manufactured by a conventional method.

In addition, treatment for silicifying, boronizing, carbonizing, and incorporating nitrogen, phosphorus and the like can be conducted at the time of sintering.

The pressure in the sintering is, for example, preferably reduced pressure of 10² Pa or less. The sintering temperature is preferably 1,000 to 2,000° C., more preferably 1,100 to 1,700° C., still more preferably 1,200 to 1,600° C.

<Chemical Conversion Step>

In the chemical conversion step, a dielectric layer is formed on the surface layer of the anode body obtained in the above-described sintering step. A dielectric layer can be formed by conducting chemical conversion treatment. The chemical conversion treatment can be conducted by a conventional method. Either of chemical oxidation or electrolytic oxidation may be employed or both may be conducted repeatedly.

Chemical oxidation can be conducted by immersing the anode body in the chemical conversion liquid.

Electrolytic oxidation is conducted by immersing the anode body in the chemical conversion liquid and applying voltage thereto. The voltage is applied between the anode body (anode) and the counter electrode (cathode). Current can be passed through the anode body through the anode lead wire. The application of voltage is started at a predetermined initial current density; the current density is maintained until the voltage reaches a predetermined voltage (chemical formation voltage); and after that it is desirable to maintain the voltage value. The chemical formation voltage can be appropriately configured depending on a predetermined withstand voltage.

There is no particular limit on the chemical conversion liquid, and an aqueous solution containing an oxidizing agent used in a conventional method can be used.

As a chemical conversion liquid when tantalum is used as a valve-acting metal, for example, an aqueous solution of phosphoric acid, an aqueous solution of nitric acid, an aqueous solution of sulfuric acid and the like can be used.

When tungsten is used as a valve-acting metal, examples of the preferred oxidizing agent include at least one member selected from the group consisting of a manganese(VII) compound, a chromium(VI) compound, a halogen acid compound, a persulfate compound and organic peroxide. Specific examples include a manganese(VII) compound such as permanganate; a chromium(VI) compound such as chrome trioxide, chromate and dichromate; a halogen acid compound such as perchloric acid, chlorous acid, hypochlorous acid and salts thereof; organic acid peroxide such as acetyl hydroperoxide and perbenzoic acid, and salts and derivatives thereof; a persulfuric acid compound such as persulfate and salts thereof. Among these, persulfate such as ammonium persulfate, potassium persulfate, potassium hydrogen persulfate are preferable from the viewpoint of handleability, stability as an oxidizing agent, high solubility in water, and capacity-increasing performance. These oxidizing agents can be used solely or in combination of two or more thereof.

As a chemical conversion liquid when aluminum is used as a valve-acting metal, for example, an aqueous solution containing neutral salt such as ammonium adipate and ammonium benzoate can be used.

In the chemical conversion, a known jig may be used. Examples of the jig include the one disclosed by Japanese Patent No. 4620184.

The concentration of the oxidizing agent, the chemical conversion temperature and the chemical conversion time can be determined according to a conventional method, and there is no particular limit thereto.

After the chemical conversion treatment, the anode body may be washed with water. By washing with water, it is desirable to remove the chemical conversion liquid as much as possible. After washing with water, it is desirable to remove water attached on the surface or permeated in the fine pores of the anode body. Water is removed by, for example, bringing water into contact with a water-miscible solvent (propanol, ethanol, methanol and the like), followed by drying by heating. The temperature of the heating treatment is preferably 100 to 200° C. or higher. The heating treatment time is not particularly limited as long as the time falls within a range that can maintain the stability of the dielectric layer.

<Step of Forming a Semiconductor Layer>

In the step of forming a semiconductor layer, a semiconductor layer is formed by immersing the anode body having formed a dielectric layer thereon by the above-mentioned method in a solution of monomers of the conductive polymer and polymerizing the monomers.

In the present invention, the step of forming a semiconductor layer is conducted under the condition where photopolymerization of the monomers of the conductive polymer is not caused to prevent the darkening and floating substances in the monomer solution.

In the case of actually forming a semiconductor layer by conducting electrolytic polymerization with respect to the tungsten anode body having a dielectric layer comprising tungsten trioxide using a solution of ethylenedioxythiophene monomer for six hours under a fluorescent light, the monomer solution after the formation of the semiconductor layer is darkened and low-molecular-weight polymer refuse is to float or precipitate. On the other hand, when the electrolytic polymerization is conducted in a dark place, the monomer solution after the electrolytic polymerization is transparent.

The condition where photopolymerization of the monomers of the conductive polymer is not caused is preferably a condition that a cumulative light amount for radiation of the light having a wavelength of 150 to 450 nm in the step of forming a semiconductor layer is set to 10 mJ/cm² or less.

The cumulative light amount is preferably 8 mJ/cm² or less, more preferably 6 mJ/cm² or less, and still more preferably 4 mJ/cm² or less.

Examples of the light source include a fluorescent light, sunlight, a light bulb, a halogen lamp, a xenon lamp, LED and laser beam.

Examples of a method for setting a cumulative light amount for radiation of the light having a wavelength of 150 to 450 nm to 10 mJ/cm² or less include a method of using a light-shielding film or a yellow booth.

The condition where photopolymerization of the monomers of the conductive polymer is not caused is more preferably a light-shielding condition. A light-shielding condition means a condition substantially cut off from the light, preferably a state in a dark room or a state in which the reactor is entirely covered.

The condition where photopolymerization of the monomers of the conductive polymer is not caused varies somewhat depending on the kind of the valve-acting metal and the conductive polymer. Therefore, the detailed conditions may be determined by conducting a preliminary experiment.

As a conductive polymer of the semiconductor layer, for example, polyethylenedioxythiophene, polypyrrole or a derivative and a mixture thereof can be used. Before, after or during the formation of a semiconductor layer, a layer comprising manganese dioxide or a layer dotted with manganese dioxide may be formed.

The liquid used for polymerization of the monomers of the conductive polymer may contain dopants. Examples of the dopants include toluenesulfonic acid, anthraquinonesulfonic acid, benzoquinonesulfonic acid, naphthalenesulfonic acid, polystyrenesulfonic acid and a salt thereof.

Either of chemical polymerization and electrolytic polymerization may be used for the polymerization of monomers of a conductive polymer, and both may be conducted repeatedly. In any of the cases of conducting polymerization in either of the two ways, it is desirable to conduct polymerization under the condition where photopolymerization of the monomers of the conductive polymer is not caused.

Chemical polymerization can be conducted by immersing the anode body in a polymerization solution.

Electrolytic polymerization can be conducted by immersing the anode body in a polymerization solution and applying a voltage thereto. A voltage can be applied in the same way as in the electrolytic oxidation in the chemical conversion step, and it is desirable to apply current under constant current conditions.

There is no particular limit on the concentrations of a monomer of the conductive polymer and a dopant, the polymerization temperature, and the polymerization time, and these can be determined according to the usual method.

After the formation of a semiconductor layer, washing and heating treatment may be conducted in the same way as in the chemical conversion step. However, the temperature of the heating treatment is preferably lower than that in the chemical conversion step to keep the semiconductor layer from deteriorating.

After the formation of a semiconductor layer, post-chemical conversion may be conducted to repair defects generated in the dielectric layer.

The post-chemical conversion step can be conducted in the same way as in the chemical conversion step. However, the voltage to be applied is preferably lower than that in the chemical conversion step to keep the semiconductor layer from deteriorating.

After the post-chemical conversion, washing and heating treatment may be conducted in the same way as in the step of forming a semiconductor layer.

It is to be noted that the operations from the step of forming a semiconductor layer to the post-chemical conversion may be conducted repeatedly.

<Step of Forming a Conductor Layer>

In the step of forming a conductor layer, a conductor layer is formed on the anode body having a semiconductor layer formed thereon by the above-described method. The conductor layer can be formed by the usual method, and examples thereof include a method of sequentially laminating a silver layer on a carbon layer.

The capacitor element as discussed above can be made into solid electrolytic capacitor products for various uses with an outer jacket formed by resin molding and the like.

A cathode lead is electrically connected to the conductor layer, and a part of the cathode lead is exposed outside the outer jacket of the electrolytic capacitor to serve as a cathode external terminal. On the other hand, an anode lead is electrically connected to the anode body through an anode lead wire, and a part of the anode lead is exposed outside the outer jacket of the electrolytic capacitor to serve as an anode external terminal.

As a resin type used for resin-mold jacketing, those used in the usual method such as epoxy resin, phenol resin, alkyd resin, ester resin, allyl ester resin, and a mixture thereof can be used.

It is desirable to conduct the encapsulation by transfer molding.

According to the method of the present invention, a capacitor can be mounted on various electric circuits or electronic circuits to be used.

### EXAMPLES

The present invention is described below by referring to Examples and Comparative Examples, but the present invention is not limited thereto.

In the present invention, the particle diameter (volume-average particle diameter) of a powder was measured by using HRA9320-X100 (laser diffraction/scattering method particle size analyzer) manufactured by Microtrac Inc. Specifically, a volume-based particle size distribution was measured by the equipment. A particle size value when the accumulated volume % corresponded to 50 volume % in the particle size distribution was designated as the volume-average particle size D50 (μm).

### Example 1, Comparative Example 1

### (1) Sintering Step

After forming a commercially-available tantalum powder (manufactured by Global Advanced Metals Pty Ltd; trade name: S-10) with a tantalum wire having a diameter of 0.24 mm, the formed bodies were sintered in vacuum at 1,320° C. for 30 minutes to produce 1,000 pieces of anode body having a size of 1.0×2.3×1.7 mm. A tantalum lead wire was implanted in the center of the 1.0×2.3 mm surface. The tantalum wire was implanted so that it was embedded 1.2 mm inside the molded body and protruded outside by 8.5 mm.

### (2) Chemical Conversion Step

Next, the tantalum wire of the anode body was plugged into a socket of the same jig as that used in Example 1 of Japanese Patent No. 4620184 to array 64 pieces of the anode bodies. Five jigs in which the anode bodies were arrayed in the same way were prepared. Using these jigs, the anode body and the predetermined part of the tantalum wire were immersed in an aqueous solution of 2 mass % phosphoric acid and chemical conversion treatment was conducted at 60° C. and 10 V for 5 hours to form a dielectric layer comprising tantalum pentoxide.

### (3) Step of Forming a Semiconductor Layer

Next, after immersing the anode body subjected to chemical conversion treatment in an ethanol solution of 10 mass % ethylenedioxythiophene, chemical polymerization was conducted using a separately prepared aqueous solution of 10 mass % iron toluenesulfonate at 60° C. for 15 minutes. The series of the operations from the immersion to chemical polymerization was repeated three times in total.

Subsequently, a solution containing 3 mass % of anthraquinone sulfonic acid and ethylenedioxythiophene in a saturated amount or more, in which the mass ratio of water to ethylene glycol was 7:3, was prepared as a monomer solution for electrolytic polymerization. The solution was put in a stainless-steel container, and the anode body was immersed in the solution to conduct electrolytic polymerization. The stainless-steel container had a solution volume of 220 ml, a size of 220×50 mm and a height of 30 mm. In the electrolytic polymerization, the tantalum wire and the stainless-steel container were connected to the positive electrode and the negative electrode of the power source, respectively, and the polymerization was conducted under constant current conditions of 60 μA/anode body at 25° C. for one hour.

After the electrolytic polymerization, washing with water and washing with ethanol were conducted, followed by heating treatment at 80° C.

### (4) Step of Post-Chemical Conversion

Next, the anode body was immersed in the same solution as that used in (2) chemical conversion step and post-chemical conversion treatment was conducted at 9V for 15 minutes.

The series of the above-described operations from the electrolytic polymerization to post-chemical conversion was repeated six times. The current value of the electrolytic polymerization was set to 70 μA/anode body in the second and third rounds, and 80 μA/anode body in the fourth to sixth rounds.

In Example 1, (3) step of forming a semiconductor layer and (4) step of post-chemical conversion were conducted under the light-shielding condition. The light-shielding condition was the state in which the reactor was entirely covered.

On the other hand, in Comparative Example 1, all the steps were conducted under a fluorescent light of 20 W. The distance from the fluorescent lamp to the solution surface was set to 110 cm.

### (5) Step of Forming a Conductor Layer

Subsequently, a carbon layer and a silver layer were sequentially formed on the surface of the semiconductor layer except for the surface in which a tantalum wire was implanted, and 320 pieces of tantalum solid electrolytic capacitor elements were produced.

### (6) Encapsulation Step

The obtained 320 pieces of the elements were encapsulated with an outer jacket of epoxy resin by transfer molding, and chip-form solid electrolytic capacitors having a size of 1.9×2.8×3.4 mm were produced. The 1.9×2.8 mm surface was made parallel to the 1.0×2.3 mm surface of the anode body.

Examples 2 to 3, Comparative Example 2:

### (1) Sintering Step

0.3 mass % of commercially-available silicon powder (volume-average particle diameter D50: 1 μm) was mixed with a tungsten powder obtained by reducing a tungsten trioxide powder in a hydrogen atmosphere (volume-average particle diameter D50: 0.2 μm), and heated in vacuum at 1,100° C. for 30 minutes. After the heating, the powder was cooled to room temperature and then taken out to air, followed by crushing. The obtained tungsten granulated powder (volume-average particle diameter D50: 59 μm) was sintered in the same way as in Example 1 except that the sintering temperature was changed to 1,260° C. to thereby produce an anode body. The ratio of the density of the sintered body to that of the formed body was 1.09.

### (2) Chemical Conversion Step

Chemical conversion was conducted in the same way as in Example 1 except that an aqueous solution of 3 mass % ammonium persulfate was used as a solution and the chemical conversion temperature was changed to 50° C.

Example 2 and Comparative Example 2 were conducted by performing (3) step of forming a semiconductor layer, (4) step of post-chemical conversion, (5) step of forming a conductor layer and (6) encapsulation step in the same way as in Example 1 and Comparative Example 1, respectively.

Example 3 was conducted in the same way as in Comparative Example 2 except that a 20 W fluorescent lamp was changed to a 1 W miniature bulb.

Table 1 shows the states of the monomer solutions after the polymerization, and the number of the elements in which a foreign substance was attached to the semiconductor layer in Examples 1 to 3 and Comparative Examples 1 to 2. When calculated on the assumption that the ratio of the light having wavelength of 150 to 450 nm is 30% in the case of a 20 W fluorescent lamp and 5% in the case of a 1 W miniature bulb, the cumulative light amount for radiation of the light having that wavelength was 365 mJ/cm² in Comparative Examples 1 to 2, and 3.0 mJ/cm² in Example 2.

TABLE 1

| | | | | Number of elements in |
|---|---|---|---|---|
| | | Light condition in | States of the solution | which a foreign |
| | Valve- | the step of forming | of monomers after the | substance is attached to |
| | acting | a semiconductor | formation of a | the semiconductor layer |
| | metal | layer | semiconductor layer | (pieces/320 pieces) |
| Example 1 | Tantalum | Light-shielding | Colorless and | 0 |
| | | condition | transparent | |
| Comparative | | Under a 20 W | Darkening and | 83 |
| Example 1 | | fluorescent lamp | floating products | Defective sealing was |
| | | | were generated | caused |
| Example 2 | Tungsten | Light-shielding | Colorless and | 0 |
| | | condition | transparent | |
| Example 3 | | Under a 1 W | Colorless and | 0 |
| | | miniature bulb | transparent | |
| Comparative | | Under a 20 W | Darkening and | 175 |
| Example 2 | | fluorescent lamp | floating products | Defective sealing was |
| | | | were generated | caused |

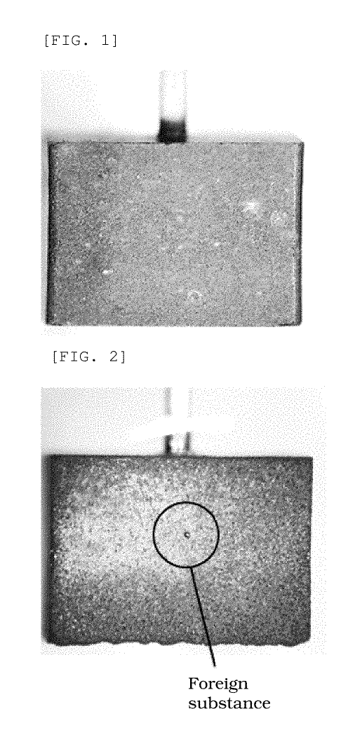

FIG. 1 and FIG. 2 are stereomicroscope photos (20-fold magnification) for showing the surface of the anode body after the step of forming a semiconductor layer in Example 2 and Comparative Example 1, respectively. In FIG. 2, an attachment of a foreign substance can be observed near the center of the photo, while such a foreign substance is not observed in FIG. 1.

In Examples 1 and 2 in which the step of forming a semiconductor layer was conducted under the light-shielding condition and in Example 3 in which the step was conducted under the condition where photopolymerization of the monomers of the conductive polymer is not caused, the solution of monomers was colorless and transparent, and no element in which a foreign substance was attached to the semiconductor layer was found. On the other hand, in Comparative Examples 1 to 2 in which the step of forming a semiconductor layer was conducted under a fluorescent light, the darkening and floating products were generated in the solution of monomers after the formation of a semiconductor layer, resulting in defective sealing.

As discussed above, it was confirmed that the generation of the darkening and floating products in the solution of monomers can be prevented by conducting the step of forming a semiconductor layer under the condition where photopolymerization of the monomers of the conductive polymer is not caused.

1. A method for producing a solid electrolytic capacitor element, which comprises, in the following order, a sintering step of sintering a valve-acting metal to form an anode body, a chemical conversion step to form a dielectric layer on the surface layer of the anode body, a step of forming a semiconductor layer comprising a conductive polymer by immersing the anode body in a solution of monomers of a conductive polymer to thereby polymerize the monomers, and a step of forming a conductor layer on the anode body; and which is characterized in conducting the step of forming a semiconductor layer under the condition where photopolymerization of the monomers of the conductive polymer is not caused.

2. The method for producing a solid electrolytic capacitor element as claimed in claim 1, wherein the condition where photopolymerization of the monomers of the conductive polymer is not caused is a condition that a cumulative light amount for radiation of the light having a wavelength of 150 to 450 nm in the step of forming a semiconductor layer is set to 10 mJ/cm² or less.

3. The method for producing a solid electrolytic capacitor element as claimed in claim 1, wherein the conductive polymer is at least one member selected from polyethylenedioxythiophene, polypyrrole, and derivatives thereof.

4. The method for producing a solid electrolytic capacitor element as claimed in claim 1, wherein the condition where photopolymerization of the monomers of the conductive polymer is not caused is a light-shielding condition.

5. The method for producing a solid electrolytic capacitor element as claimed in claim 1, wherein the valve-acting metal is at least one member selected from tantalum, niobium, tungsten and aluminum.

6. The method for producing a solid electrolytic capacitor element as claimed in claim 5, wherein the valve-acting metal is tantalum and/or tungsten.
